(19) United States
(12) Patent Application Publication
(10) Pub. No.: US 2026/0139181 A1
(43) Pub. Date: May 21, 2026

(54) FIBER INCORPORATED THIXOTROPIC CEMENT SLURRY FOR LOST CIRCULATION APPLICATION

(71) Applicant: Halliburton Energy Services, Inc., Houston, TX (US)

(72) Inventors: Sandip Prabhakar Patil, Pune (IN); Samuel J. Lewis, Houston, TX (US); Ganesh Shriniwas Pangu, Pune (IN)

(21) Appl. No.: 18/954,796

(22) Filed: Nov. 21, 2024

(51) Int. Cl. C09K 8/487; C04B 14/04; C04B 14/06; C04B 14/38; C04B 14/46; C04B 24/10; C04B 28/04; E21B 33/14

(52) U.S. Cl. CPC C09K 8/487; C04B 14/042; C04B 14/06; C04B 14/386; C04B 14/4668; C04B 24/10; C04B 28/04; E21B 33/14; C09K 2208/08

(57) ABSTRACT

Cement compositions and methods of using the composition wherein the cement compositions comprise water, a hydraulic cement, diutan gum, amorphous silica, sepiolite, and a plurality of needle-shaped fibers, and the method includes providing the cement composition, introducing the cement composition downhole into a well; and allowing the cement composition to set therein.

### FIELD

The present disclosure relates to the field of subterranean well cementing operations and, more particularly, to methods of cementing using cement compositions.

### BACKGROUND

Hydraulic cement compositions commonly are utilized in subterranean operations, particularly subterranean well completion and remedial operations. For example, hydraulic cement compositions are used in cementing operations whereby pipe strings, such as casing and liners, are cemented in wellbores. In performing primary cementing, a hydraulic cement composition may be pumped into an annulus between the walls of a wellbore and the exterior surface of the pipe string disposed therein. The cement composition sets in the annular space, thereby forming therein an annular sheath of hardened, substantially impermeable cement that supports and positions the pipe string in the wellbore and bonds the exterior surface of the pipe string to the walls of the wellbore. Hydraulic cement compositions also may be used in remedial cementing operations, such as plugging wellbores, plugging highly permeable zones or fractures in wellbores, plugging cracks and holes in pipe strings, and the like.

Gel strength of the cement slurries can be important for many reasons. For example, sufficient gel strength in cement slurries allows them to function as lost circulation prevention additives. Lost circulation occurs when cement flows into the formation and can have a variety of negative effects, including impairment of production for oil and/or gas-bearing formations. Cement additives can confer sufficient gel strength in cement to prevent or decrease lost circulation. This may be particularly helpful in low-density cement slurries.

Additionally, sufficient gel strength, tortuosity, and viscosity in cement slurries allow them to function as gas migration control additives. Gas migration occurs when gas enters the cement. The gas may create channels in the cement, which may lead to a variety of problems. Gas migration control may provide greater cement integrity and improved zonal isolation, reduced expenses for remedial squeeze cementing, less chance of damaging tubulars in the casing, and a lower risk of downhole blowouts.

Accordingly, cement compositions displaying enhanced gel strength are important and desirable in downhole operations.

### BRIEF DESCRIPTION OF THE DRAWINGS

The drawings included with this application illustrate certain aspects of the embodiments described herein. However, the drawings should not be viewed as exclusive embodiments. The subject matter disclosed herein is capable of considerable modifications, alterations, combinations, and equivalents in form and function, as will be evident to those skilled in the art with the benefit of this disclosure.

FIG. 1 illustrates a system for preparation and delivery of a cement composition to a wellbore in accordance with aspects of the present disclosure.

FIG. 2A illustrates surface equipment that may be used in placement of a cement composition in a wellbore in accordance with aspects of the present disclosure.

FIG. 2B illustrates placement of a cement composition into a wellbore annulus in accordance with aspects of the present disclosure.

### DETAILED DESCRIPTION

The present disclosure may be understood more readily by reference to this detailed description, including the figures. For simplicity and clarity of illustration, where appropriate, reference numerals may be repeated among the different figures to indicate corresponding or analogous elements. In addition, numerous specific details are set forth to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may have been exaggerated to better illustrate details and features of the present disclosure.

In the following discussion and in the claims, the terms “including” and “comprising” are used in an open-ended fashion, and thus should be interpreted to mean “including, but not limited to. ”. Reference to up or down will be made for purposes of description with “up,” “upper,” “upward,” or “upstream” meaning toward the surface of the wellbore and with “down,” “lower,” “downward,” or “downstream” meaning toward the terminal end of the well, regardless of the wellbore orientation.

This disclosure will be described in terms of the treatment of vertical wells but is equally applicable to wells of any orientation. This disclosure will be described for hydrocarbon production wells, but it is to be understood that this disclosure may be used for wells for the production of other fluids, such as water, or for injection or storage wells, including injection of carbon dioxide or thermal fluids as a means of a geothermal storage system. It should also be understood that throughout this specification, when a concentration or amount or other parameter range is described as useful, or suitable, or the like, it is intended that any and every concentration or amount or other parameter within the range, including the end points, is to be considered as having been stated. Furthermore, each numerical value should be read once as modified by the term “about” (unless already expressly so modified) and then read again as not to be so modified unless otherwise stated in context. For example, “a range of from 1 to 10” is to be read as indicating each and every possible number along the continuum between about 1 and about 10. In other words, when a certain range is expressed, even if only a few specific data points are explicitly identified or referred to within the range, or even when no data points are referred to within the range, it is to be understood that the inventors appreciate and understand that any and all data points within the range are to be considered to have been specified, and that the inventors have possession of the entire range and all points within the range.

Definitions: As used herein the following terms have the indicated meaning.

A “well” can include, without limitation, an oil, gas, or water production well, or an injection well. As used herein, a “well” includes at least one wellbore. A wellbore can include vertical, inclined, and horizontal sections, and it can be straight, curved, or branched. As used herein, a “well” also includes the near-wellbore region.

A near-wellbore region is the subterranean material and rock of the subterranean formation surrounding the wellbore. The near-wellbore region is generally considered to be the region within approximately 100 feet radially of the wellbore.

As used herein, “into a well” means and includes into any section of the well, including into the wellbore or into the near-wellbore region via the wellbore.

As used herein, the term “wellbore” includes any cased, and any uncased, open-hole section of the wellbore. A portion of a wellbore may be an open hole or cased hole. In an open-hole wellbore section, a tubing string may be placed into the wellbore. The tubing string allows fluids to be introduced into or flowed from a remote section of the reservoir. In a cased-hole wellbore section, a casing is placed into the wellbore that can also contain a tubing string. A wellbore can contain an annulus. Examples of an annulus include, but are not limited to: the space between the wellbore and the outside of a tubing string in an open-hole wellbore; the space between the wellbore and the outside of a casing in a cased-hole wellbore; and the space between the inside of a casing and the outside of a tubing string in a cased-hole wellbore.

“Down-hole operations” or “subterranean operations” means any operation that requires the performance of some action or procedure below the surface of the earth, including, but not limited to, actions or procedures performed while recovering oil, gas, and/or other substances from a formation below the surface of the earth. Generally, these are drilling, completion, and workover operations, and thus, include operations related to the drilling of the wellbore, operations for making the well ready for production after drilling operations, and operations to repair or stimulate an existing production well for the purpose of restoring, prolonging or enhancing the production of hydrocarbons.

“Metal-oxide based fibers” as used herein refers to needle-shaped fibers that are comprised, consist essentially of, or consist of metal oxide. Typically, these fibers will be made from metal-oxide-containing compounds such as various igneous rocks. For example, the igneous rocks could be rhyolite, andesite, basalt, and/or komatiite.

“Needle-shaped fibers” as used herein refers to fibers that have a longer length than diameter.

A “treatment fluid” is a fluid used in down-hole operations. Often these will comprise an oil or aqueous base fluid and can include gelling agents, viscosifiers, and other additives that support the downhole operation. A treatment fluid may be used in a variety of subterranean operations. As used herein, the term “treatment,” or “treating,” does not imply any particular action by the fluid or any particular component thereof, but instead refers to any use related to a subterranean operation in conjunction with a desired function and/or for a desired purpose. For example, a fluid may be used to drill a wellbore in a subterranean formation or to complete a wellbore in a subterranean formation, as well as numerous other purposes.

“Wellbore fluids” broadly refers to fluids in the wellbore and includes treatment fluids, and hydrocarbons or aqueous fluids produced from subterranean formations.

The present disclosure relates to subterranean well cementing operations and, more particularly, to methods of cementing using cement compositions comprising needle-shaped fibers. While the compositions and methods are useful in a variety of well completion and remedial operations, they are particularly useful in primary cementing, e.g., cementing casings and liners in wellbores, including those in multi-lateral subterranean wells.

The cement compositions of the present disclosure generally comprise water, hydraulic cement, diutan gum, amorphous silica, sepiolite, and a plurality of needle-shaped fibers. Typically, the cement compositions of the present disclosure may have a density in the range of from about 4 pounds per gallon (“lb/gal”) to about 20 lb/gal. In certain embodiments, the cement compositions may have a density in the range of from about 8 lb/gal to about 17 lb/gal. The cement compositions may be foamed or unfoamed or may comprise other means to reduce their densities, such as hollow microspheres, low-density elastic beads, or other density-reducing additives known in the art. Those of ordinary skill in the art, with the benefit of this disclosure, will recognize the appropriate density for a particular application.

The water used in the cement compositions of the present disclosure may be freshwater, saltwater (e.g., water containing one or more salts dissolved therein), brine (e.g., saturated saltwater produced from subterranean formations), or seawater, or combinations thereof. Generally, the water may be from any source, provided that it does not contain an excess of compounds that adversely affect other components in the cement composition. The water may be present in an amount sufficient to form a pumpable slurry. More particularly, the water may be present in the cement compositions of the present disclosure in an amount in the range of from about 33% to about 200% by weight of the cement (“bwoc”). In some embodiments, the water may be present in an amount in the range of from about 35% to about 70% bwoc.

All cements suitable for use in subterranean cementing operations may be used in accordance with the present disclosure. Suitable examples include cements comprised of calcium, aluminum, silicon, oxygen, and/or sulfur, which set and harden by reaction with water. Such hydraulic cements, include, but are not limited to, Portland cements, pozzolana cements, gypsum cements, high alumina content cements, slag cements, and silica cements, and combinations thereof. In certain embodiments, the cement may comprise a Portland cement. In some embodiments, the Portland cements that are suited for use in the present disclosure are classified as Class A, C, H, and G cements according to American Petroleum Institute, API Specification for Materials and Testing for Well Cements, API Specification 10, Fifth Ed., Jul. 1, 1990.

In general, diutan is a polysaccharide, which may be prepared by fermentation of a strain of sphingomonas. Diutan may also be referred to as a polysaccharide designated S-657 and/or S-8 in some literature. Its structure has been elucidated as having a repeat unit of a hexasaccharide with a tetrasaccharide repeat unit in the backbone that comprises glucose and rhamnose units and a di-rhamnose side chain. It is believed to have thickening, suspending, and stabilizing properties in aqueous and/or nonaqueous solutions. The diutan gum will generally be present in the cement composition in an amount in the range of from about 0.05% to about 5% by weight of the cement, optionally from 0.1% to 4%, or from 0.2% to 3% by weight of the cement.

The amorphous silica, such as silica fume, is a high surface area, non-crystalline form of silica. Amorphous silica is generally a byproduct of a ferrosilicon production process, wherein the amorphous silica may be formed by oxidation and condensation of gaseous silicon suboxide, SiO, which is formed as an intermediate during the process. An example of a suitable source of amorphous silica is Silicalite™ cement additive, available from Halliburton Energy Services, Inc. The amorphous silica can be present in the cement composition in an amount in the range of from about 2% to about 200% by weight of the cement, optionally from 3% to 175%, or from 5% to 150% by weight of the cement.

Sepiolite is a naturally occurring clay mineral of sedimentary origin. It is a non-swelling, lightweight, porous clay with a large specific surface area. Chemically, sepiolite is a hydrous magnesium silicate whose individual particles have a needle-like morphology. The high surface area and porosity of this clay account for its outstanding absorption capacity for liquids. Sepiolite granules do not disintegrate even when saturated with liquids. The sepiolite can be present in the cement composition in an amount in the range of from about 1% to about 40% by weight of the cement, optionally from 2% to 30%, or from 3% to 20% by weight of the cement.

Needle-shaped fibers are utilized in the composition, and among other things, the needle-shaped fibers may increase gel strength without any adverse effect on mixability or rheology, especially when included with the diutan, amorphous silica, and sepiolite.

Broadly, the needle-shaped fibers used in the composition of this disclosure have a length that is at least twice the diameter of the fiber. However, more typically the needle-shaped fibers have an aspect ratio (length to diameter) of at least fibers at least 2, at least 3, at least 3.4 or at least 4. Additionally, the aspect ratio can be no greater than 200 or no greater than 100. For example, the aspect ratio can be from 2 to 200, or from 3 to 100, or from 3.5 to 100.

Further, the needle-shaped fibers are small, generally less than 6 mm in length. Length here refers to the greatest dimension, and diameter refers to the lesser two dimensions of the fibers. It will be understood that the use of the term “diameter” does not necessitate that the fiber is cylindrical in shape; rather, the term is used for convenience to refer to the lesser two orthogonal dimensions of the fiber.

The needle-shaped fibers can have a length of at least 100 microns of at least 130 microns, at least 150 microns, at least 200 microns, or at least 300 microns. Generally, the length can be no greater than 6000 microns, no greater than 5500 microns, no greater than 5000 microns, or no greater than 4000 microns, or no greater than 3000 microns, or no greater than 2000 microns or no greater than 1000 microns. For example, the length can be in the range of from 100 microns to 6000 microns, from 130 microns to 5500 microns, from 130 to 5000 microns, from 130 to 4000 microns. However, the length and width should at least result in a minimum aspect ratio as recited above.

Typically, the needle-shaped fibers can have a diameter that is no more than 300 microns, no more than 250 microns, no more than 200 microns, no more than 100 microns, or no more than 70 microns. Generally, the diameter of the fibers will be at least 10 microns, at least 20 microns, or at least 40 microns. For example, the needle-shaped fibers can have a diameter in the range of 10 to 300 microns, or from 20 to 200 microns, from 40 to 100 microns, or from 40 to 70 microns.

Generally, the needle-shaped fibers will be inorganic fibers. For example, the needle-shaped fibers can be selected from the group consisting of carbon fibers, metal-oxide-based fibers, and combinations thereof. For example, needle-shaped fibers can be selected from the group consisting of carbon fibers, basalt fibers, and combinations thereof. For example, the needle-shaped fibers can consist essentially of or can consist of carbon fibers or can consist essentially of or can consist of basalt fibers.

Basalt fibers generally are produced from basalt, which is an igneous rock that is generally comprised of microscopic grains, such as calcium-sodium (plagioclase) feldspar, pyroxene, and olivine. Suitable basalt fibers are commercially available from Forta Corporation, Grove City, Pa.

Any suitable method for the production of inorganic fibers may be used for the production of the needle-shaped fibers included in the cement compositions of the present disclosure. In some embodiments, needle-shaped fibers may be produced by a process of extrusion through fine holes, which determines the diameter of the fibers. In some embodiments, needle-shaped fibers may be produced by melt spinning. The diameter and length of the basalt fibers may be controlled during the preparation thereof.

The needle-shaped fibers should be present in the cement compositions of the present disclosure in an amount sufficient to provide the desired gel strength increase. For example, the needle-shaped fibers can be present in the cement compositions in an amount in the range of from about 1.0% to about 25% by weight of the cement, optionally from 2.0% to 20%, or from 2.5% to 15% by weight of the cement.

Other additives suitable for use in subterranean wellbore cementing operations also may be added to these compositions. Other additives, include but are not limited to, defoamers, dispersants, retardants, accelerants, fluid loss control additives, weighting agents, vitrified shale, lightweight additives (e.g., bentonite, gilsonite, glass spheres, etc.), silica flour, lignosulfonate-based organic acid (such as HR-12 from Halliburton Energy Services), and fly ash, and combinations thereof. A person having ordinary skill in the art, with the benefit of this disclosure, will know the type and amount of additive useful for a particular application and desired result.

The exemplary compositions disclosed herein may directly or indirectly affect one or more components or pieces of equipment associated with the preparation, delivery, recapture, recycling, reuse, and/or disposal of the disclosed compositions. For example, the disclosed compositions may directly or indirectly affect one or more mixers, related mixing equipment, mud pits, storage facilities or units, composition separators, heat exchangers, sensors, gauges, pumps, compressors, and the like used to generate, store, monitor, regulate, and/or recondition the exemplary compositions. The disclosed compositions may also directly or indirectly affect any transport or delivery equipment used to convey the compositions to a wellsite or downhole such as, for example, any transport vessels, conduits, pipelines, trucks, tubulars, and/or pipes used to compositionally move the compositions from one location to another, any pumps, compressors, or motors (e.g., topside or downhole) used to drive the compositions into motion, any valves or related joints used to regulate the pressure or flow rate of the compositions, and any sensors (i.e., pressure and temperature), gauges, and/or combinations thereof, and the like. The disclosed binder compositions may also directly or indirectly affect the various downhole equipment and tools that may come into contact with the cement compositions/additives such as, but not limited to, wellbore casing, wellbore liner, completion string, insert strings, drill string, coiled tubing, slickline, wireline, drill pipe, drill collars, mud motors, downhole motors and/or pumps, cement pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like.

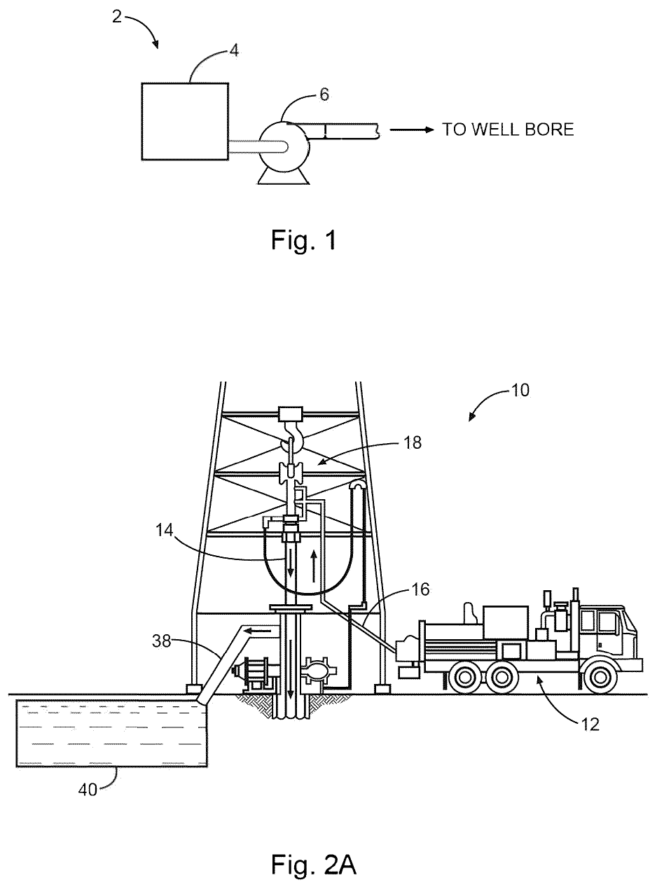

Referring now to FIG. 1, a system that may be used in the preparation of a cement composition in accordance with example embodiments will now be described. FIG. 1 illustrates system 2 for preparation of a cement composition and delivery to a wellbore in accordance with certain embodiments. As shown, the cement composition may be mixed in mixing equipment 4, such as a jet mixer, re-circulating mixer, or a batch mixer, for example, and then pumped via pumping equipment 6 to the wellbore. In some embodiments, the mixing equipment 4 and the pumping equipment 6 may be disposed on one or more cement trucks as will be apparent to those of ordinary skill in the art. In some embodiments, a jet mixer may be used, for example, to continuously mix the composition, including water, as it is being pumped to the wellbore.

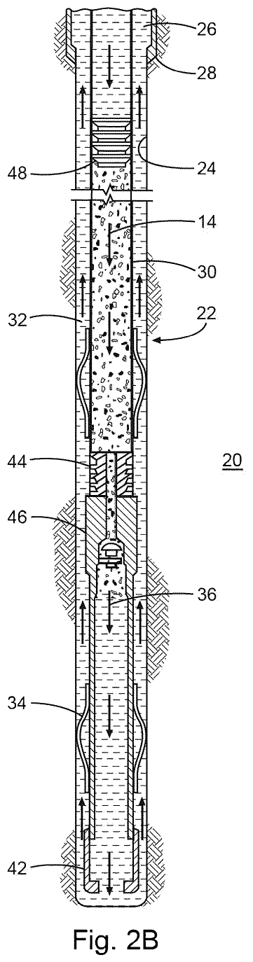

An example technique and system for placing a cement composition into a subterranean formation will now be described with reference to FIGS. 2A and 2B. FIG. 2A illustrates surface equipment 10 that may be used in the placement of a cement composition in accordance with certain embodiments. It should be noted that while FIG. 2A generally depicts a land-based operation, those skilled in the art will readily recognize that the principles described herein are equally applicable to subsea operations that employ floating or sea-based platforms and rigs, without departing from the scope of the disclosure. As illustrated by FIG. 2A, surface equipment 10 may include a cementing unit 12, which may include one or more cement trucks. The cementing unit 12 may include mixing equipment 4 and pumping equipment 6 (e.g., FIG. 1) as will be apparent to those of ordinary skill in the art. The cementing unit 12 may pump a cement composition 14 through a feed pipe 16 and to a cementing head 18 which conveys the cement composition 14 downhole.

Turning now to FIG. 2B, the cement composition 14 may be placed into a subterranean formation 20 in accordance with example embodiments. As illustrated, a wellbore 22 may be drilled into the subterranean formation 20. While wellbore 22 is shown extending generally vertically into the subterranean formation 20, the principles described herein are also applicable to wellbores that extend at an angle through the subterranean formation 20, such as horizontal and slanted wellbores. As illustrated, the wellbore 22 comprises walls 24. In the illustrated embodiments, a surface casing 26 has been inserted into the wellbore 22. The surface casing 26 may be cemented to the walls 24 of the wellbore 22 by cement sheath 28. In the illustrated embodiment, one or more additional conduits (e.g., intermediate casing, production casing, liners, etc.) shown here as casing 30 may also be disposed in the wellbore 22. As illustrated, there is a wellbore annulus 32 formed between the casing 30 and the walls 24 of the wellbore 22 and/or the surface casing 26. One or more centralizers 34 may be attached to the casing 30, for example, to centralize the casing 30 in the wellbore 22 prior to and during the cementing operation.

With continued reference to FIG. 2B, the cement composition 14 may be pumped down the interior of the casing 30. The cement composition 14 may be allowed to flow down the interior of the casing 30 through the casing shoe 42 at the bottom of the casing 30 and up around the casing 30 into the wellbore annulus 32. The cement composition 14 may be allowed to set in the wellbore annulus 32, for example, to form a cement sheath that supports and positions the casing 30 in the wellbore 22. While not illustrated, other techniques may also be utilized for the introduction of the cement composition 14. By way of example, reverse circulation techniques may be used that include introducing the cement composition 14 into the subterranean formation 20 by way of the wellbore annulus 32 instead of through the casing 30.

As it is introduced, the cement composition 14 may displace other fluids 36, such as drilling fluids and/or spacer fluids, that may be present in the interior of the casing 30 and/or the wellbore annulus 32. At least a portion of the displaced fluids 36 may exit the wellbore annulus 32 via a flow line 38 and be deposited, for example, in one or more retention pits 40 (e.g., a mud pit), as shown in FIG. 2A. Referring again to FIG. 2B, a bottom plug 44 may be introduced into the wellbore 22 ahead of the cement composition 14, for example, to separate the cement composition 14 from the fluids 36 that may be inside the casing 30 prior to cementing. After the bottom plug 44 reaches the landing collar 46, a diaphragm or other suitable device ruptures to allow the cement composition 14 through the bottom plug 44. In FIG. 2B, the bottom plug 44 is shown on the landing collar 46. In the illustrated embodiment, a top plug 48 may be introduced into the wellbore 22 behind the binder composition 14. The top plug 48 may separate the cement composition 14 from a displacement fluid 50 and also push the cement composition 14 through the bottom plug 44.

The above method, its steps, and systems incorporating the method can be better understood by the following examples, which support and illustrate the process and composition. The examples are to facilitate a better understanding of the present disclosure but should not be read as limiting or defining the scope of the disclosure.

### Examples

Eight 12 lb/gal slurry designs were prepared. All the slurries had the same amounts of Class G Cement, silica fume, diutan, sepiolite, SSA-1, and HR-12 as shown in Table 1. SSA-1 is silica four, HR-12 is a lignosulfonate-based organic acid, both from Halliburton Energy Services, Inc., of Duncan, OK. Slurry 1 had no fiber. The other slurries had either 5% or 10% by weight of cement (bwoc) of a fiber a basalt fiber (having a length of approximately 150 microns), a carbon fiber (having a length of approximately 100 microns), a polypropylene fiber (having a length of approximately 3000 microns), or a natural cellulosic fiber (having a length of approximately 40 microns). The fibers and amounts are shown in Table 1. Rheology and gel strength measurements at about 87.8° C. (190° F.) were taken and the results are reported in Table 1.

TABLE 1
12 lb/gal Slurry Designs

| | Slurry | Slurry | Slurry | Slurry | Slurry | Slurry | Slurry | Slurry |
|---|---|---|---|---|---|---|---|---|
| Materials | # 1 | # 2 | # 3 | # 4 | # 5 | # 6 | # 7 | # 8 |

Density: 12 ppg

| | | | | | | | | |
|---|---|---|---|---|---|---|---|---|
| Class G Cement, | 100 | 100 | 100 | 100 | 100 | 100 | 100 | 100 |
| % bwoc | | | | | | | | |
| Diutan, lb/bbl | 0.9 | 0.9 | 0.9 | 0.9 | 0.9 | 0.9 | 0.9 | 0.9 |
| Sepiolite, lb/bbl | 6.3 | 6.3 | 6.3 | 6.3 | 6.3 | 6.3 | 6.3 | 6.3 |
| Silica Fume, lb/bbl | 34.9 | 34.9 | 34.9 | 34.9 | 34.9 | 34.9 | 34.9 | 34.9 |
| SSA-1, % bwoc | 15 | 15 | 15 | 15 | 15 | 15 | 15 | 15 |
| HR-12, % bwoc | 0.7 | 0.7 | 0.7 | 0.7 | 0.7 | 0.7 | 0.7 | 0.7 |
| Basalt Fiber, % bwoc | — | 5 | 10 | — | — | — | — | — |
| Carbon Fiber, % bwoc | — | — | — | 5 | 10 | — | — | — |
| Polypropylene Fiber, | — | — | — | — | — | 5 | 2.5 | — |
| % bwoc | | | | | | | | |
| Cellulosic Fiber, | — | — | — | — | — | — | — | 10 |
| % bwoc | | | | | | | | |

Rheology and Gel Strength on FYSA at 190° F.

| | | | | | | | | |
|---|---|---|---|---|---|---|---|---|
| 3 rpm | 21 | 23 | 24 | 25 | 28 | 49 | 27 | 20 |
| 6 rpm | 22 | 24 | 25 | 26 | 28 | 50 | 28 | 21 |
| 100 rpm | 24 | 26 | 26 | 28 | 32 | 58 | 32 | 27 |
| 200 rpm | 26 | 28 | 29 | 31 | 35 | 64 | 36 | 30 |
| 300 rpm | 30 | 31 | 33 | 35 | 39 | 73 | 40 | 33 |
| 10 sec. gel strength, | 28 | 32 | 35 | 36 | 39 | 47 | 34 | 25 |
| lbf/100 ft² | | | | | | | | |
| 10 min. gel strength, | 108 | 178 | 194 | 202 | 208 | 135 | 116 | 68 |
| lbf/100 ft² | | | | | | | | |

As can be seen in Table 1, the addition of 5% and 10% bwoc Basalt fiber (slurry 2 and 3) increases the gel strength by 70 and 86 lbf/100 ft², respectively, over slurry 1, which had no fiber. Whereas the addition of the same amount of carbon fiber (slurry 4 and 5) increases the gel strength by 94% and 100% lbf/100 ft², respectively. Addition of these fibers does not have any adverse effect on mixability as well as rheology. In slurry 6 and 7, polypropylene fibers were added at 5% AND 2.5% BWOC. Slurry 6 (5% bwoc) became viscous with slight improvement in gel strength; however, the viscosity increased too much. The increase in viscosity can be attributed to the significantly higher size of the polypropylene fibers (approximately 3000 microns). Slurry 7 and slurry 8 (natural cellulosic fibers) did not show any improvement in gel strength build up with slurry 8 actually exhibiting a decrease in gel strength build up.

Seven 10 lb/gal slurry designs were prepared with the components described above and as shown in Table 2. Rheology and gel strength measurements at about 87.8° C. (190° F.) were taken and the results are reported in Table 2.

TABLE 2
10 lb/gal Slurry Designs

| | Slurry | Slurry | Slurry | Slurry | Slurry | Slurry | Slurry |
|---|---|---|---|---|---|---|---|
| Materials | # 9 | # 10 | # 11 | # 12 | # 13 | # 14 | # 15 |

Density: 10 ppg

| | | | | | | | |
|---|---|---|---|---|---|---|---|
| Class G Cement, % bwoc | 100 | 100 | 100 | 100 | 100 | 100 | 100 |
| Diutan, lb/bbl | 0.8 | 0.8 | 0.8 | 0.8 | 0.8 | 0.8 | 0.8 |
| Sepiolite, lb/bbl | 5.3 | 5.3 | 5.3 | 5.3 | 5.3 | 5.3 | 5.3 |
| Silica Fume, lb/bbl | 29.9 | 29.9 | 29.9 | 29.9 | 29.9 | 29.9 | 29.9 |
| SSA-1, % bwoc | 15 | 15 | 15 | 15 | 15 | 15 | 15 |
| HR-12, % bwoc | 1.0 | 1.0 | 1.0 | 1.0 | 1.0 | 1.0 | 1.0 |
| Basalt Fiber, % bwoc | — | 5 | 10 | — | — | — | — |
| Carbon Fiber, % bwoc | — | — | — | 2.5 | 5 | 10 | 15 |

Rheology and Gel Strength on FYSA at 190° F.

| | | | | | | | |
|---|---|---|---|---|---|---|---|
| 3 rpm | 6 | 6 | 6 | 6 | 6 | 6 | 6 |
| 6 rpm | 6 | 7 | 7 | 6 | 6 | 6 | 6 |
| 100 rpm | 8 | 8 | 8 | 8 | 8 | 8 | 7 |
| 200 rpm | 11 | 11 | 11 | 10 | 11 | 10 | 11 |
| 300 rpm | 15 | 15 | 16 | 15 | 15 | 15 | 15 |
| 10 sec. gel strength, | 9 | 12 | 14 | 10 | 11 | 11 | 11 |
| lbf/100 ft² | | | | | | | |
| 10 min. gel strength, | 111 | 159 | 170 | 115 | 154 | 149 | 146 |
| lbf/100 ft² | | | | | | | |

Like the 12 1 lb/gal design above, the 10 1 lb/gal design showed improved gel strength build-up without affecting the mixability and rheology of the slurries when basalt fibers or carbon fibers are incorporated in the slurry. It was found that around 5% to 10% bwoc of fibers are optimal to improve the gel strength at lower density.

The above disclosure, and embodiments thereunder, are exemplified by methods and systems defined by the following numbered cases; however, the embodiments are not limited to the following numbered cases.
Case 1: A method comprising:
   providing a cement composition that comprises water, a hydraulic cement, diutan gum, amorphous silica, sepiolite, and a plurality of needle-shaped fibers;
   introducing the cement composition downhole into a well; and
   allowing the cement composition to set therein.
Case 2: The method of case 1, wherein the water is selected from the group consisting of: freshwater; saltwater; a brine; seawater; and combinations thereof.
Case 3: The method of either case 1 or case 2, wherein the cement is selected from the group consisting of: a Portland cement; a pozzolana cement; a gypsum cement; a high alumina content cement; a slag cement; a silica cement; and combinations thereof.
Case 4: The method of any preceding case, wherein the needle-shaped fibers have an aspect ratio of at least 2, optionally of 2 to 200, or 3 to 100, or 3.5 to 100.
Case 5: The method of any preceding case, wherein the needle-shaped fibers have a diameter in the range of from 10 microns to 300 microns, optionally from 20 to 200 microns, or from 40 to 100 microns.
Case 6: The method of any preceding case, wherein the needle-shaped fibers have a length in the range of from 100 to 6000 microns, optionally from 130 to 5500 microns, or from 130 to 5000 microns, or from 130 to 4000 microns.
Case 7: The method of any preceding case, wherein the needle-shaped fibers are present in the cement composition in an amount in the range of from about 1.0% to about 25% by weight of the cement, optionally from 2.0% to 20%, or from 2.5% to 15% by weight of the cement.
Case 8: The method of any preceding case, wherein:
   the diutan gum is present in the cement composition in an amount in the range of from about 0.05% to about 5% by weight of the cement, optionally from 0.1% to 4%, or from 0.2% to 3% by weight of the cement; and/or
   the amorphous silica is present in the cement composition in an amount in the range of from about 2% to about 200% by weight of the cement, optionally from 3% to 175%, or from 5% to 150% by weight of the cement; and/or
   sepiolite is present in the cement composition in an amount in the range of from about 1% to about 40% by weight of the cement, optionally from 2% to 30%, or from 3% to 20% by weight of the cement.
Case 9: The method of any preceding case, wherein the needle-shaped fibers are inorganic fibers.
Case 10: The method of case 9, wherein the needle-shaped fibers are selected from the group consisting of carbon fibers, metal-oxide-based fibers, and combinations thereof.
Case 11: The method of either case 9, wherein the needle-shaped fibers are selected from the group consisting of carbon fiber, basalt fibers, and mixtures thereof, and optionally the needle-shaped fibers consist of carbon fibers, or optionally the needle-shaped fibers consist of basalt fibers.
Case 12: The method of any preceding case, wherein the step of introducing the cement composition downhole into a well comprises introducing the cement composition into a subterranean formation.
Case 13: The method of any of cases 1 to 11, wherein the step of introducing the cement composition downhole into a well comprises introducing the cement composition into an annulus between at least one wall of the wellbore and a pipe string disposed within the wellbore.
Case 14: The method of any preceding case, further comprising mixing the components of the cement composition using mixing equipment.
Case 15: The method of any preceding case, wherein the cement composition is introduced into the wellbore using one or more pumps.
Case 16: The method of any preceding case, wherein the addition of the needle-shaped fibers increases gel strength over the cement composition without the needle-shaped fibers and without any adverse effect on mixability or rheology.
Case 17: A cement composition comprising water, a hydraulic cement, diutan gum, amorphous silica, sepiolite, and a plurality of needle-shaped fibers.
Case 18: The cement composition of case 17, wherein the water is selected from the group consisting of: freshwater; saltwater; a brine; seawater; and combinations thereof.
Case 19: The cement composition of either case 17 or case 18, wherein the cement is selected from the group consisting of: a Portland cement; a pozzolana cement; a gypsum cement; a high alumina content cement; a slag cement; a silica cement; and combinations thereof.
Case 20: The cement composition of any of cases 17 to 19, wherein the needle-shaped fibers have an aspect ratio of at least 2, optionally of 2 to 200, or 3 to 100, or 3.5 to 100.
Case 21: The cement composition of any of cases 17 to 20, wherein the needle-shaped fibers have a diameter in the range of from 10 microns to 300 microns, optionally from 20 to 200 microns, or from 40 to 100 microns, and wherein the needle-shaped fibers have a length in the range of from 100 to 6000 microns, optionally from 130 to 5500 microns, or from 130 to 5000 microns, or from 130 to 4000 microns.
Case 22: The cement composition of any of cases 17 to 21, wherein the needle-shaped fibers are present in the cement composition in an amount in the range of from about 1.0% to about 25% by weight of the cement, optionally from 2.0% to 20%, or from 2.5% to 15% by weight of the cement.
Case 23: The cement composition of any of cases 17 to 22, wherein:
   the diutan gum is present in the cement composition in an amount in the range of from about 0.05% to about 5% by weight of the cement, optionally from 0.1% to 4%, or from 0.2% to 3% by weight of the cement; and/or
   the amorphous silica is present in the cement composition in an amount in the range of from about 2% to about 200% by weight of the cement, optionally from 3% to 175%, or from 5% to 150% by weight of the cement; and/or
   sepiolite is present in the cement composition in an amount in the range of from about 1% to about 40% by weight of the cement, optionally from 2% to 30%, or from 3% to 20% by weight of the cement.
Case 24: The cement composition of any of cases 17 to 23, wherein the needle-shaped fibers are inorganic fibers.
Case 25: The cement composition of case 24, wherein the needle-shaped fibers are selected from the group of consisting of carbon fibers, metal-oxide-based fibers, and combinations thereof.
Case 26: The cement composition of claim 24, wherein the needle-shaped fibers are selected from the group consisting of carbon fiber, basalt fibers, and mixtures thereof, and optionally the needle-shaped fibers consist of carbon fibers, or optionally the needle-shaped fibers consist of basalt fibers.
Case 27: The cement composition of any of cases 17 or 26, wherein the addition of the needle-shaped fibers increases gel strength over the cement composition without the needle-shaped fibers and without any adverse effect on mixability or rheology.

Therefore, the present compositions and methods are well adapted to attain the ends and advantages mentioned, as well as those that are inherent therein. The particular examples disclosed above are illustrative only, as the present treatment additives and methods may be modified and practiced in different but equivalent manners apparent to those skilled in the art having the benefit of the teachings herein. Furthermore, no limitations are intended to be the details of construction or design herein shown, other than as described in the claims below. It is therefore evident that the particular illustrative examples disclosed above may be altered or modified, and all such variations are considered within the scope and spirit of the present treatment additives and methods. While compositions and methods are described in terms of “comprising,” “containing,” “having,” or “including” various components or steps, the compositions and methods can also, in some examples, “consist essentially of” or “consist of” the various components and steps.

A component that “comprises” or “includes” one or more specified compounds means that the component includes the specified compound(s) alone or includes the specified compound(s) together with one or more additional compounds.

A component that “consists of” one or more specified compounds means that the component includes only the specified compound(s).

A component that “consists essentially of” one or more specified compounds means that the component consists of the specified compound(s) alone or consists of the specified compound(s) together with one or more additional compounds that do not materially affect the basic properties of the component.

Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee.

1. A method comprising:
providing a cement composition that comprises water, a hydraulic cement, diutan gum, amorphous silica, sepiolite, and a plurality of needle-shaped fibers;
introducing the cement composition downhole into a well; and
allowing the cement composition to set therein.

2. The method of claim 1, wherein the water is selected from the group consisting of: freshwater; saltwater; a brine; seawater; and combinations thereof, and wherein the cement is selected from the group consisting of: a Portland cement; a pozzolana cement; a gypsum cement; a high alumina content cement; a slag cement; a silica cement; and combinations thereof.

3. The method of claim 1, wherein the needle-shaped fibers have an aspect ratio of at least 2.

4. The method of claim 3, wherein the needle-shaped fibers have a diameter in the range of from 10 microns to 300 microns, and wherein the needle-shaped fibers have a length in the range of from 100 to 6000 microns.

5. The method of claim 4, wherein:
the needle-shaped fibers are present in the cement composition in an amount in the range of from about 1.0% to about 25% by weight of the cement;
the diutan gum is present in the cement composition in an amount in the range of from about 0.05% to about 5% by weight of the cement;
the amorphous silica is present in the cement composition in an amount in the range of from about 2% to about 200% by weight of the cement; and
sepiolite is present in the cement composition in an amount in the range of from about 1% to about 40% by weight of the cement.

6. The method of claim 5, wherein the needle-shaped fibers are inorganic fibers.

7. The method of claim 6, wherein the needle-shaped fibers are selected from the group of consisting of carbon fibers, metal-oxide based fibers, and combinations thereof.

8. The method of claim 6, wherein the needle-shaped fibers are selected from the group consisting of carbon fiber, basalt fibers and mixtures thereof.

9. The method of claim 6, wherein the step of introducing the cement composition downhole into a well comprises introducing the cement composition into a subterranean formation.

10. The method of claim 6, wherein the step of introducing the cement composition downhole into a well comprises introducing the cement composition into an annulus between at least one wall of the wellbore and a pipe string disposed within the wellbore.

11. The method of claim 6, wherein the addition of the needle-shaped fibers increases gel strength over the cement composition without the needle-shaped fibers and without any adverse effect on mixability or rheology.

12. A cement composition comprising water, a hydraulic cement, diutan gum, amorphous silica, sepiolite, and a plurality of needle-shaped fibers.

13. The cement composition of claim 12, wherein the water is selected from the group consisting of: freshwater; saltwater; a brine; seawater; and combinations thereof, and wherein the cement is selected from the group consisting of: a Portland cement; a pozzolana cement; a gypsum cement; a high alumina content cement; a slag cement; a silica cement; and combinations thereof.

14. The cement composition of claim 13, wherein the needle-shaped fibers have an aspect ratio of at least 2.

15. The cement composition of claim 14, wherein the needle-shaped fibers have a diameter in the range of from 10 microns to 300 microns, and wherein the needle-shaped fibers have a length in the range of from 100 to 6000 microns.

16. The cement composition of claim 15, wherein:
the needle-shaped fibers are present in the cement composition in an amount in the range of from about 1.0% to about 25% by weight of the cement;
the diutan gum is present in the cement composition in an amount in the range of from about 0.05% to about 5% by weight of the cement;
the amorphous silica is present in the cement composition in an amount in the range of from about 2% to about 200% by weight of the cement; and
sepiolite is present in the cement composition in an amount in the range of from about 1% to about 40% by weight of the cement.

17. The cement composition of claim 16, wherein the needle-shaped fibers are inorganic fibers.

18. The cement composition of claim 17, wherein the needle-shaped fibers are selected from the group of consisting of carbon fibers, metal-oxide based fibers, and combinations thereof.

19. The cement composition of claim 17, wherein the needle-shaped fibers are selected from the group consisting of carbon fiber, basalt fibers and mixtures thereof.

20. The cement composition of claim 17, wherein the addition of the needle-shaped fibers increases gel strength over the cement composition without the needle-shaped fibers and without any adverse effect on mixability or rheology.
